(19) United States
(12) Patent Application Publication
(10) Pub. No.: US 2009/0046448 A1
(43) Pub. Date: Feb. 19, 2009

(54) Rotatable illumination device on hand tools

(76) Inventor: Hung-He Huang, Taichung (TW)

Correspondence Address: HUANG, Hung-He, P.O. Box 44-2049, Taipei, 10668, TW

(21) Appl. No.: 11/889,669

(22) Filed: Aug. 15, 2007

(51) Int. Cl. B25B 23/18

(52) U.S. Cl. 362/119

(57) ABSTRACT

A saw includes a handle and a blade which is fixed to the handle. The handle includes a recess defined in a side thereof and an illumination device is rotatably connected to the recess of the handle. The illumination device includes a light emitting member and a switch connected thereto. The user may rotate the illumination device to adjust the direction of the light beam from the light emitting member.

### BACKGROUND OF THE INVENTION

(1) Field of the Invention

The present invention relates to a rotatable illumination device connected to a handle of a hand tool such as a saw so as to provide illumination feature.

(2) Description of the Prior Art

A conventional illumination device generally is fixed to the handle of a hand tool and emits a light beam to form a guide line on the object to be cut. However, once the illumination device on a hand tool is damaged, the whole handle has to be replaced. Another illumination device for a saw 40 is shown in FIG. 6 and the saw 40 generally includes a blade 41 and a handle 42 which has a rail 421 extending from an underside thereof and an extension 50 has a groove 51 with which the rail 421 is engaged. A light unit 52 is connected to the extension 50 so as to emit a light beam to illuminate the object. However, the extension 50 increases the space required when operating the saw 40 so that the extension 50 may not be inserted into a narrow space when using the saw 40. Besides, the direction of the light unit 52 is fixed and may not be satisfied to the users.

The present invention intends to provide an illumination device on hand tools, wherein the illumination device is attached to the hand tool by magnetic force and can be rotated as desired.

### SUMMARY OF THE INVENTION

The present invention relates to a saw which comprises a handle having a recess defined in a side thereof and a blade has an end fixed to the handle. An illumination device is rotatably connected to the recess of the handle and includes a light emitting member connected thereto.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the saw and the illumination device of the present invention;

FIG. 1A shows the illumination device of the present invention;

FIG. 2 is a perspective view to show the saw with the illumination device of the present invention connected thereto;

FIGS. 3A and 3B show that the illumination device of the present invention is rotated in different angles;

FIG. 4 is a side view to show that the illumination device of the present invention emits a light beam to illuminate the object to be cut;

FIG. 5 shows that the saw with the illumination device of the present invention is about to cut an object, and

FIG. 6 shows a saw with a conventional illumination device connected thereto.

### DETAILED DESCRIPTION OF THE PREFERRED EMBODIMENTS

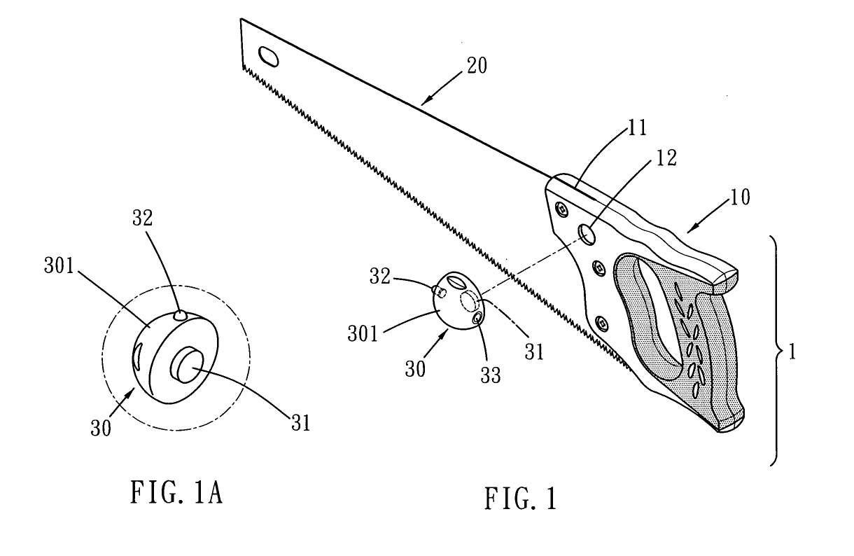

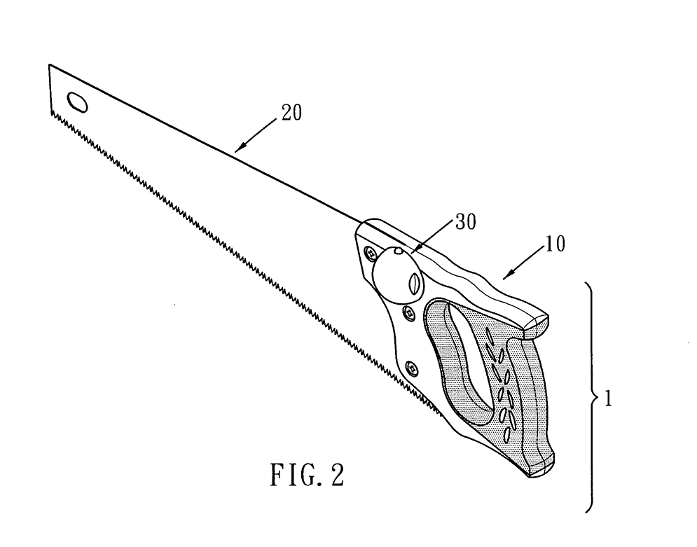

Referring to FIGS. 1, 1A and 2, the saw 1 includes a handle 10 which has a slit 11 defined in an end thereof and an end of a blade 20 is securely inserted into the slit 11. A recess 12 is defined in a side of the handle 10 and includes a magnetic inside. An illumination device 30 includes semi-spherical case 301 in which circuit board, wires and battery are received. A light emitting member 32 and a switch 33 are connected to an outer surface of the semi-spherical case 301. A protrusion 31 extends from an underside of the semi-spherical case 301 and is rotatably attracted to the magnetic inside of the recess 12. The light emitting member 32 can be a light emitting diode and the number of the light emitting member 32 can be multiple.

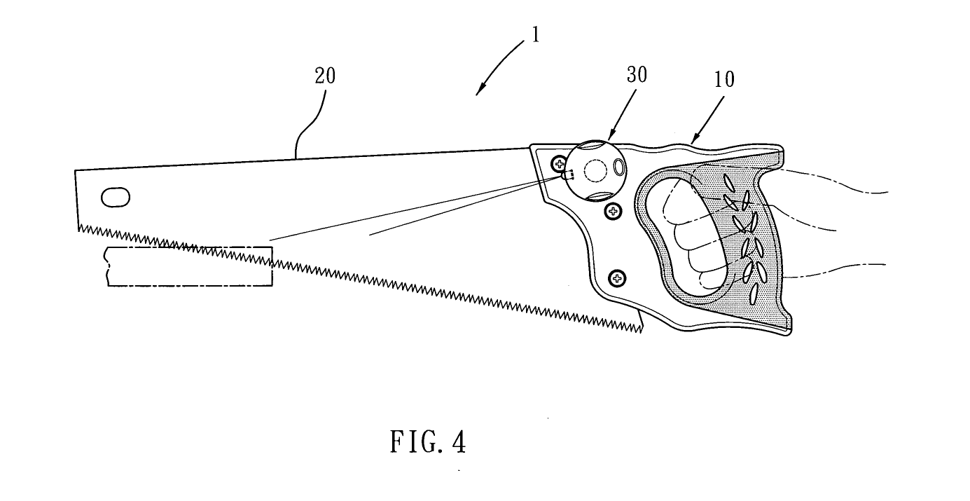

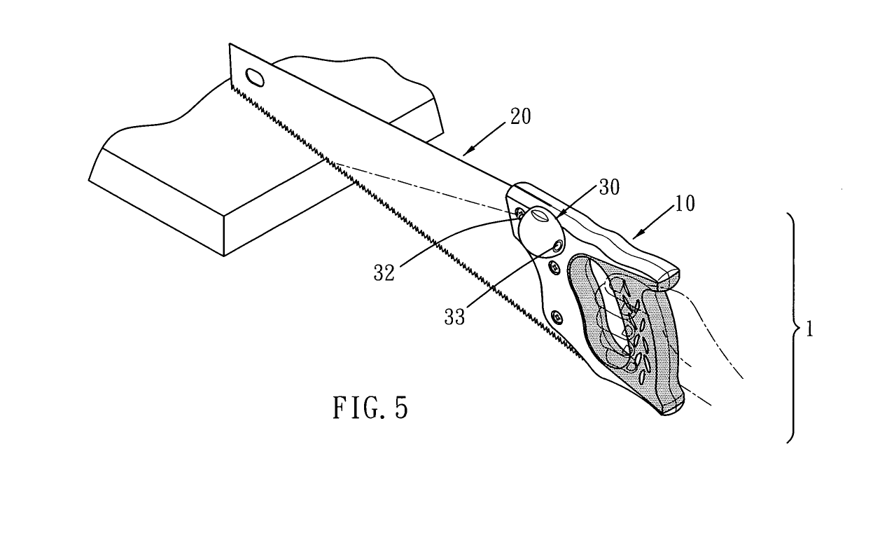

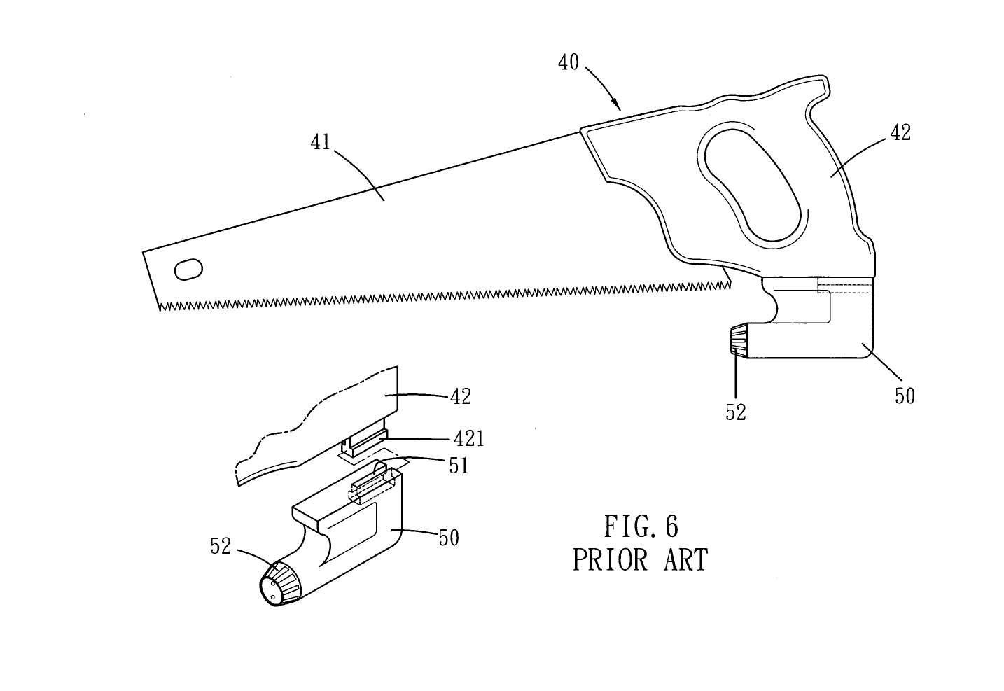

As shown in FIGS. 4 and 5, the light beam from the light emitting member 32 illuminates the object to be cut and the light emitting member 32 does not occupy too much space so that it does not affect the use of the saw 1.

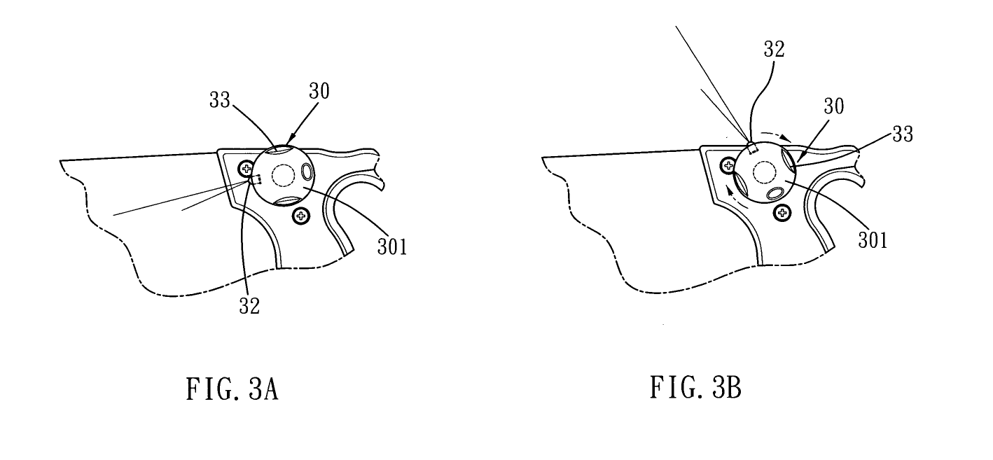

As shown in FIGS. 3A and 3B, the user can rotate the semi-spherical case 301 to adjust the direction of the light beam emitted from the light emitting member 32.

The illumination device 30 can also be used independently as a general illuminating device and the protrusion 31 can also be made by magnetic material so that it is easily to attach on a metal object.

While we have shown and described the embodiment in accordance with the present invention, it should be clear to those skilled in the art that further embodiments may be made without departing from the scope of the present invention.

What is claimed is:

1. A saw comprising:
a handle having a recess defined in a side thereof;
a blade having an end fixed to the handle, and
an illumination device rotatably connected to the recess of the handle and including a light emitting member connected thereto.

2. The saw as claimed in claim 1, wherein the handle includes a slit defined in an end thereof and the end of the blade is securely inserted into the slit.

3. The saw as claimed in claim 1, wherein the recess includes a magnetic inside and the illumination device includes a protrusion which is rotatably attracted to the magnetic inside of the recess.

4. The saw as claimed in claim 1, the illumination device includes a semi-spherical case and the light emitting member and a switch are connected to an outer surface of the semi-spherical case.
